(19) United States
(12) Patent Application Publication
(10) Pub. No.: US 2026/0253198 A1
(43) Pub. Date: Aug. 27, 2026

(54) Visual Inspection Method for Crimping Quality of Automotive Wiring Harnesses

(71) Applicants: Hubei University of Arts and Science, Xiangyang City (CN); Xiangyang Qunlong Automotive Parts Co., Ltd, Xiangyang City (CN)

(72) Inventors: Jinquan NIE, Xiangyang City (CN); Siyuan LIU, Xiangyang City (CN); Changfu WANG, Xiangyang City (CN); Sitan YUE, Xiangyang City (CN)

(73) Assignees: Hubei University of Arts and Science, Xiangyang City (CN); Xiangyang Qunlong Automotive Parts Co., Ltd, Xiangyang City (CN)

(21) Appl. No.: 19/636,871

(22) Filed: Apr. 1, 2026

Related U.S. Application Data
(63) Continuation of application No. PCT/CN2026/075372, filed on Jan. 28, 2026.

(30) Foreign Application Priority Data
Feb. 22, 2025 (CN) 2025101996130

(51) Int. Cl. G06T 7/00; G01N 21/952; G06T 7/12; G06T 7/62; H01B 13/012

(52) U.S. Cl. CPC G06T 7/0006; G01N 21/952; G06T 7/12; G06T 7/62; H01B 13/01209; G06T 2207/20032; G06T 2207/30108

(57) ABSTRACT

A visual inspection method for crimping quality of automotive wiring harness. The method comprises: performing denoising, grayscale conversion, and binarization processing on a wiring harness image to determine white connected regions corresponding to wiring harnesses; calculating the number of wiring harness strands based on the white connected regions, and comparing the number with a preset standard value; if the number is consistent with the preset standard value, performing edge extraction to determine a length of the wiring harness, and determining whether the length is within a preset dimensional range; after the condition is satisfied, segmenting the wiring harness image into single-wire-strand images according to a preset order, and calculating a first-order color moment and a second-order color moment in an HSV color space for each single-wire-strand image, and comparing the calculated moments with template wiring harness values; if differences are within a threshold range, segmenting a wiring harness crimping area and generating a binary image thereof; detecting defects in the crimping area using a pre-trained defect instance segmentation model, generating a defect mask, and calculating compactness of a contact surface; if no defect is detected and the compactness conforms to a standard, completing inspection of a qualified wiring harness.

### INCORPORATION BY REFERENCE

This application is a continuation of international application number PCT/CN2026/075372 filed Jan. 28, 2026, which claims priority to China Patent Application number 2025101996130 filed Feb. 22, 2025, the contents of each of which are hereby incorporated by reference in their entirety.

### TECHNICAL FIELD

The present application pertains to the technical field of automotive electronic product inspection. More specifically, it relates to a visual inspection method for crimping quality of automotive wiring harnesses.

### BACKGROUND TECHNOLOGY

In the production process of automotive wiring harnesses, the inspection of crimping quality is a crucial step to ensure the safety and reliability of automotive electrical systems. Currently, the inspection of automotive wiring harness crimping quality primarily employs methods such as mechanical testing, electrical testing, and microscopic observation. Mechanical testing evaluates crimping strength and consistency by applying external force. Electrical testing utilizes methods like continuity testing and insulation resistance testing to assess the conductivity and insulation performance of crimping points. Microscopic observation involves magnifying and analyzing the appearance characteristics of a crimping area with the aid of microscopes or industrial cameras.

However, these traditional inspection methods have apparent drawbacks and limitations. Firstly, mechanical testing and microscopic observation typically require manual involvement, making the inspection process cumbersome and inefficient, which struggles to meet the high-volume, fast-paced production demands of the modern automotive industry. Secondly, electrical testing methods cannot visually evaluate the appearance quality of crimping points and find it difficult to detect issues such as over-crimping or under-crimping, lacking a comprehensive assessment of multi-dimensional quality characteristics of harness crimps. Furthermore, traditional inspection methods are susceptible to subjective human judgment or variations in equipment accuracy, making it challenging to guarantee consistency in inspection results, which can easily lead to misjudgments or missed defects.

With the rapid development of the automotive industry, higher requirements have been placed on the accuracy and efficiency of wiring harness crimping quality inspection. Therefore, developing an efficient, accurate, and intelligent method for inspecting the crimping quality of automotive wiring harnesses has become an urgent problem to be solved.

### SUMMARY OF THE INVENTION

In view of the foregoing, the present application provides a visual inspection method for crimping quality of automotive wiring harnesses, which combines modern visual inspection and artificial intelligence technologies to achieve efficient, intelligent, and automated crimping quality inspection for automotive wiring harnesses.

The technical solution provided by the present application is detailed as follows:

A visual inspection method for crimping quality of automotive wiring harnesses, sequentially performing wire strand sequence inspection, dimension inspection, and crimping defect inspection on a wiring harness based on an image thereof, the method comprising:
processing an image of the wiring harness through grayscale conversion, denoising, and binarization to identify white connected regions corresponding to wiring harnesses within the harness image;
determining the number of wire strands based on the white connected regions corresponding to wiring harnesses;
in response to the number of wire strands matching a first preset standard value, performing edge extraction on the harness image to obtain edge pixels of the wire strands and determining a length of the wiring harness based on the edge pixels;
in response to the length conforming to a preset dimensional range, segmenting the harness image into a plurality of single-wire-strand images according to a preset initial sequence;
extracting first-order and second-order color moments for each single-wire-strand image in an HSV color space, and comparing differences between the extracted color moments and template values for corresponding positions of single wire strands;
in response to all the differences being within a preset threshold range, cropping a wiring harness crimping area from the harness image and generating a binary image of the wiring harness crimping area;
processing the binary image using a pre-trained defect instance segmentation model for crimping areas to generate a defect mask, wherein the defect mask marks crimping defects within the wiring harness crimping area and is used to determine a compactness of the crimping area based on a perimeter and an area of a contact surface thereof; and
in response to processing no crimping defect and the compactness matching a second preset standard value, completing quality inspection for a qualified wiring harness.

In one possible implementation, processing the harness image through grayscale conversion, denoising, and binarization comprises:
converting the harness image to the HSV color space and using a Value (V) component thereof as a grayscale image;
performing median filtering on the grayscale image to remove noise and smooth the harness image; and
performing binarization on the denoised grayscale image to segment the harness image into a black background region and the white connected regions corresponding to wiring harnesses.

In one possible implementation, determining the number of wire strands based on the white connected regions corresponding to wiring harnesses:
performing an erosion operation on the binarized image to remove extraneous noise points, thereby obtaining a final wiring harness image; wherein the white connected regions corresponding to wiring harnesses in the final wiring harness image consist solely of the wire strands and are used to determine the number of wire strands.

In one possible implementation, performing edge extraction on the harness image to obtain edge pixels of the wire strands, and determining a length of the wiring harness comprises:
extracting edge information of the wire strands from the harness image based on a Canny edge detection algorithm to determine an edge contour;
randomly selecting N pixel points on the edge contour to perform a Randomized Hough Transform;
identifying a line with a maximum number of collinear points by analyzing peaks in a Hough space as an entire harness line L, the harness line L comprising a straight-line segment I₁ and a curved segment I₂;
calculating a length of the straight-line segment I₁, wherein the length is a Euclidean distance between two endpoints of the straight-line segment I₁ and is calculated using a linear equation y₁ thereof:

$${l}_{1} = \sqrt{{( {y}_{a} - {y}_{b} )}^{2} + {( {x}_{a} - {x}_{b} )}^{2}} \qquad ( 2 )$$

where A(xₐ, yₐ),B(x_{b}, y_{b}) are the two endpoints of the straight-line segment; calculating a length of the curved segment I₂, wherein the length is calculated using a curve equation y₂ thereof:

$${l}_{2} = {\int }_{c}^{d} \sqrt{{[ {f}^{′} ( x ) ]}^{2} + 1} d x \qquad ( 3 )$$

where c and d are horizontal coordinates of the two endpoints of the curved segment;
using a sum of the length of the straight-line segment I₁ and the length of the curved segment I₂ as the length of the wiring harness in the harness image; and
determining an actual length of the wiring harness based on a length of the wiring harness in the harness image and a preset scaling factor;

In one possible implementation, determining the preset dimensional range comprises:
selecting n different sets of sample harnesses, and for each set i, calculating an error uᵢ=Aᵢ−Mᵢ between an actual value Aᵢ and a measured value Mᵢ; calculating an average error

$${u}_{0} = \frac{1}{n} {\sum }_{i = 1}^{n} {u}_{i} ;$$

calculating an error threshold ε₀, expressed as:

$${ε}_{0} = \frac{1}{n} {\sum }_{i = 1}^{n} {( {u}_{i} - {u}_{0} )}^{2}$$

measuring a same sample harness m times to obtain a plurality of measured values

$${M}_{i}^{′}$$

for that same sample harness, and determining a systematic error ε₁, expressed as:

$${ε}_{1} = \frac{1}{m} {\sum }_{i = 1}^{m} {( {M}_{i}^{′} - {M}_{0}^{′} )}^{2}$$

where determining the preset dimensional range based on the error threshold ε₀, the systematic error ε₁, and a preset template value; wherein the length of the wiring harness is determined to conform to the preset dimensional range if a difference between the length of the wiring harness and the preset template value is within a threshold range of (ε₀+ε₁).

In one possible implementation, extracting the first-order and second-order color moments for each single-wire-strand image in the HSV color space comprises:
extracting pixel values of the single-wire-strand image on the H, S, and V color components;
determining the first-order color moment and the second-order color moment corresponding to the single-wire-strand image based on the pixel values; wherein the first-order color moment is expressed as:

$${e}_{i} = \frac{1}{N} {\sum }_{j = 1}^{N} {P}_{i , j} \qquad ( 6 )$$

where N represents a total number of pixels in the single-wire-strand image, P_{i,j} represents a j-th pixel value of an i-th color component, and eᵢ represents a mean value of all pixels for the i-th color component, which is a value of the first-order color moment;
wherein the second-order color moment is expressed as:

$${S}_{i} = {[ \frac{1}{N} {\sum }_{j = 1}^{N} {( {P}_{i , j} - {e}_{i} )}^{2} ]}^{\frac{1}{2}} \qquad ( 7 )$$

where Sᵢ represents a variance of all pixels for the i-th color component, which is the second-order color moment.

In one possible implementation, cropping the wiring harness crimping area from the harness image and generating the binary image of the wiring harness crimping area comprises:
cropping the wiring harness crimping area from the harness image based on an adaptive threshold segmentation algorithm;
for each pixel in an image of the cropped wiring harness crimping area, with the pixel as a center, defining a 3×3 neighborhood window that consists of the center pixel and eight adjacent pixels surrounding the center pixel;
calculating a mean of grayscale values of all pixels within the 3×3 neighborhood window;
using the mean as a threshold T(x,y) for the current pixel, expressed as:

$$T ( x , y ) = {\sum }_{( i . j ) ∋ W} I ( i , j ) - C \qquad ( 8 )$$

where T(x,y) represents the threshold for the current pixel, W represents the neighborhood window centered on the current pixel, I(i, j) represents the grayscale value of a pixel within the neighborhood window, and C represents a constant for adjusting segmentation sensitivity;
comparing the grayscale value of the current pixel with the calculated threshold T(x, y); setting the current pixel to white if the grayscale value of the current pixel is greater than T(x, y); setting the current pixel to black if the grayscale value of the current pixel is less than or equal to T(x, y);
repeating the foregoing steps for each pixel in the image of the wiring harness crimping area to generate the binary image of the wiring harness crimping area; wherein a white region in the binary image represents the wiring harness crimping area of the wiring harness, and a black region represents a background or other non-crimping areas.

In one possible implementation, the pre-trained defect instance segmentation model for crimping areas is a YOLACT instance segmentation model, using ResNet50 as a backbone network;
wherein training the defect instance segmentation model for crimping areas comprises:
acquiring a plurality of images containing various types of crimping defects to construct a crimping area defect dataset, wherein the types of crimping defects comprise crack defects, abnormal crimping shape defects, crimping surface oxidation defects, and wire strand exposure defects in crimping areas;
inputting the crimping area defect dataset into a configured YOLACT instance segmentation model, and extracting feature information through the backbone network, the feature information being expressed as:

$$F ∈ {R}^{C \times H \times W} \qquad ( 9 )$$

where F represents the feature map dimension, C represents the number of feature channels, H represents a height of the feature map, and W represents a width of the feature map;
performing dimensionality reduction on the feature tensor F, using a 1×1 convolution kernel to reduce the number of feature channels C in the feature tensor F to 32 to serve as the number of shared mask prototypes;
determining a shared mask dimension P, expressed as:

$$P ∈ {R}^{M \times H \times W} \qquad ( 10 )$$

performing normalization on an original prediction value Ci of the YOLACT instance segmentation model through an activation function to obtain mask weight coefficients cᵢₘ, wherein the mask weight coefficients characterize a contribution degree of shared mask prototypes to a specific target instance, expressed as:

$${C}_{i} = \{ {C}_{i 1} , {C}_{i 2} , … , {C}_{iM} \} \qquad ( 11 )$$

$${c}_{im} = sigmoid ( {C}_{i} ) \qquad ( 12 )$$

performing a linear combination on the shared masks to generate a final instance mask \hat{M}ᵢ(x, y), thereby obtaining the trained defect instance segmentation model for crimping areas, expressed as:

$${\hat{M}}_{i} ( x , y ) = {\sum }_{m = 1}^{M} {C}_{i m} \times {P}_{m} ( x , y ) \qquad ( 13 )$$

where M represents the number of shared masks, \hat{M}ᵢ(x,y) represents a final mask for an i-th instance, Pₘ(x,y) represents an m-th shared mask prototype, and Cᵢₘ represents an m-th weight for the instance i; and
optimizing the network using a binary cross-entropy loss function to enhance an ability of the defect instance segmentation model for crimping areas to distinguish between different types of crimping defects, the loss function being expressed as:

$${L}_{m a s k} = - \frac{1}{N} {\sum }_{i = 1}^{N} {\sum }_{( x , y )} [ {M}_{i} ( x , y ) log ( {\hat{M}}_{i} ( x , y ) ) + ( 1 - {M}_{i} ( x , y ) log ( 1 - {\hat{M}}_{i} ( x , y ) ) ) ] \qquad ( 14 )$$

where Mᵢ(x,y) represents a ground truth mask annotated using Labelme software, and \hat{M}ᵢ(x,y) represents a predicted mask.

In one possible implementation, marking crimping defects within the wiring harness crimping area and determining a compactness of the crimping area based on the defect mask comprises:
performing contour extraction on the defect mask using OpenCV to obtain a point set of an image contour of the crimping area, expressed as:

$$contour = \{ ( {x}_{1} , {y}_{1} ) , ( {x}_{2} , {y}_{2} ) , … , ( {x}_{n} , {y}_{n} ) \} \qquad ( 15 )$$

calculating a distance di between adjacent points based on the contour expressed as:

$${d}_{i} = \sqrt{{( {x}_{i + 1} - {x}_{i} )}^{2} + {( {y}_{i + 1} - {y}_{i} )}^{2}} , i = 1 , 2 , … , n ; \qquad ( 16 )$$

where (xᵢ yᵢ) represents coordinates of an i-th point on the contour, n represents a total number of contour points, and xₙ₊₁=x₁,yₙ₊₁=y₁;
determining a contour perimeter D based on the distances between adjacent points, expressed as:

$$D = {\sum }_{i = 1}^{n} {d}_{i} \qquad ( 17 )$$

determining an area A of the contact surface of the crimping area based on a polygon area calculation formula, expressed as:

$$A = \frac{1}{2} \vert {\sum }_{i = 1}^{n} ( {x}_{i} {y}_{i + 1} - {x}_{i + 1} {y}_{i} ) \vert \qquad ( 18 )$$

where (xᵢ,yᵢ) represents coordinates of an i-th point on the contour, n represents a total number of contour points, and xₙ₊₁=x₁,yₙ₊₁=y₁;
and determining a compactness of the contact surface of the crimping area based on the perimeter D and the area A, expressed as:

$$Compactness = \frac{{D}^{2}}{4 π \times A} . \qquad ( 19 )$$

Compared with the prior art, the technical solution provided in the present application offers the following beneficial effects:

The present application achieves efficient and precise inspection of wiring harness quality by combining image processing and deep learning. First, through preprocessing operations such as denoising, grayscale conversion, binarization, and edge extraction performed on the harness image, image noise is effectively removed, enabling clear identification of connected regions and edge features of the wiring harness. This provides an accurate basis for subsequent wire strand counting and length measurement. Second, utilizing first-order and second-order color moments in the HSV color space for feature extraction and comparing them with template harness values allows for rapid determination of whether the color characteristics of the wiring harness conform to standards, thereby improving inspection sensitivity and accuracy. Furthermore, based on a pre-trained defect instance segmentation model for crimping areas, the method performs inspection on the wiring harness crimping area, accurately identifies crimping defects and generates defect masks, while further verifying crimping quality by calculating the compactness of the contact surface. The entire solution not only achieves comprehensive inspection of wiring harness quality but also significantly improves inspection efficiency, reduces errors and labor intensity associated with manual inspection. It exhibits high practicality and reliability, can be effectively applied to quality control during the wiring harness production process, and ensures high quality and consistency of wiring harness products.

### BRIEF DESCRIPTION OF DRAWINGS

FIG. 1 illustrates a schematic structural diagram of a visual inspection system for crimping quality of automotive wiring harnesses provided in Embodiment 1 of the present application.

FIG. 2 illustrates a flowchart of a method for inspecting wire strand sequence and dimensions of an automotive wiring harness provided in Embodiment 2 of the present application.

FIG. 3 illustrates a flowchart of a method for inspecting a wiring harness sequence of an automotive wiring harness provided in Embodiment 2 of the present application.

FIG. 4 illustrates a flowchart of a method for inspecting wiring harness crimping defects provided in Embodiment 2 of the present application.

FIG. 5 illustrates a schematic diagram of a wiring harness crimping area provided in Embodiment 2 of the present application.

FIG. 6 illustrates a flowchart of a visual inspection method for crimping quality of an automotive wiring harness provided in Embodiment 3 of the present application.

### EMBODIMENTS

The technical solutions in the embodiments of the present application will be described clearly and completely below with reference to the accompanying drawings in the embodiments of the present application. Apparently, the described embodiments are merely some, rather than all, of the embodiments of the present application. Based on the embodiments in the present application, all other embodiments obtained by a person of ordinary skill in the art without making creative efforts shall fall within the protection scope of the present application.

### Embodiment 1

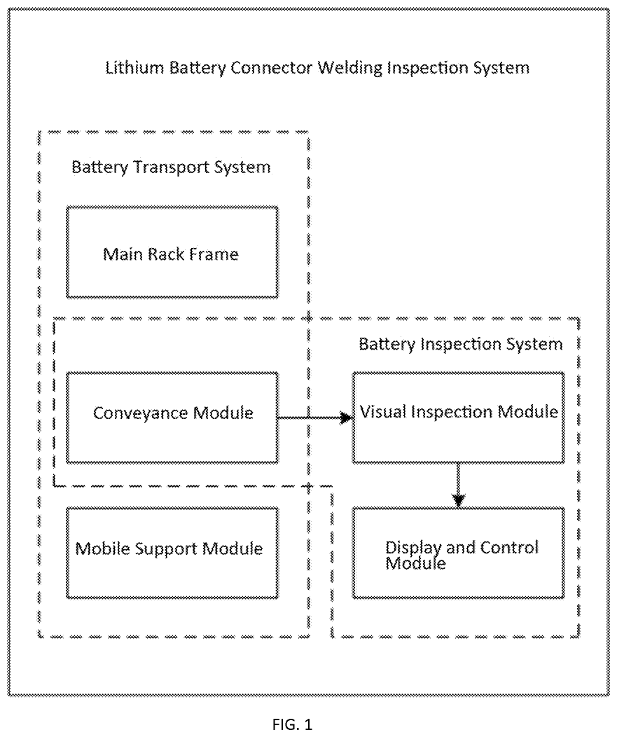

Embodiment 1 of the present application provides a schematic structural diagram of a visual inspection system for crimping quality of an automotive wiring harness. As shown in FIG. 1, the overall structure of the visual inspection system for crimping quality of an automotive wiring harness sequentially comprises, from the outside to the inside, a main rack frame, a conveyance module, a visual inspection module, a display and control module, and a mobile support module. The main rack frame is constructed using aluminum alloy profiles, serving as the primary support framework for the entire device. It is lightweight yet sturdy, providing an installation foundation and a stable operating environment for other modules. The conveyance module runs through the entire device and is installed in the middle of the main rack frame. The conveyance module connects the front and rear ends of the production line via a conveyor belt, and is used to transport an automotive wiring harness to be inspected from a starting end to an inspection area. After the inspection is completed, it continues to convey the harness to a next process or a rejection area, thereby achieving full automation of the inspection process.

The visual inspection module is installed above the conveyance module and comprises an industrial camera, a high-brightness LED light source, and a mounting bracket. The industrial camera is fixed via the mounting bracket, with its inspection area directly facing a crimping point of the wiring harness on the conveyor belt. The high-brightness LED light source is installed around the camera to provide uniform and high-intensity illumination for image acquisition, ensuring clear and reliable image quality. By adjusting the height and angle of the visual inspection module bracket, the inspection area of the industrial camera can completely cover the crimping point, thereby enabling precise inspection of the wiring harness crimping quality.

The display and control module is installed on one side of the main rack frame and consists of a display and an industrial control computer. The industrial control computer is connected to the industrial camera of the visual inspection module via a data cable and is responsible for receiving image data and performing processing and analysis. The display is connected to the industrial control computer and is used to display inspection results and an operation interface in real time, facilitating operator monitoring of the inspection process and results. The display and control module cooperates with the conveyance module and the visual inspection module via control signals to achieve automation and intellectualization of the inspection process.

The mobile support module is installed at the bottom of the device and consists of casters, which are used to facilitate movement of the device between different production lines. The arrangement of the casters provides the entire device with good flexibility and versatility, enabling it to quickly adapt to different production environments and inspection requirements, thereby improving equipment utilization rate and production efficiency.

In a specific application scenario, the embodiment of the present application first sets process parameters for the crimping quality of the automotive wiring harness and camera calibration parameters. A five-megapixel industrial camera with a resolution of 2448*2048 and a white shadowless high-brightness LED light source are selected. The wiring harness to be inspected is placed on a battery fixing platform at the starting end of the conveyor belt, and is fixed by grooves on the fixing platform. The conveyor belt operates automatically, transporting the wiring harness to be inspected to a position under the industrial camera. With the assistance of the light source, the industrial camera captures images of the wiring harness to be inspected and transmits the captured images to the industrial computer. The industrial computer analyzes the images using two built-in algorithms to detect quality parameters of the wiring harness region, comprising wire strand sequence and dimensions, as well as wiring harness crimping defects. The obtained inspection information is then compared with process standards to obtain a quality inspection result for the automotive wiring harness.

Through the rational layout and collaborative operation of the above modules, the visual inspection device for crimping quality of an automotive wiring harness of the present invention achieves fully automated operation of the entire process, from wiring harness conveyance and image acquisition to defect inspection and result display, meeting the requirements for efficient, precise, and intelligent inspection of wiring harness crimping quality in the modern automotive manufacturing industry.

The wiring harness quality inspection is divided into two parts: the first part inspects the sequence and dimensions of the wire strands, and the second part inspects crimping defects. Below, the wiring harness quality inspection methods for the above two parts are described in detail with reference to the method embodiments.

### Embodiment 2

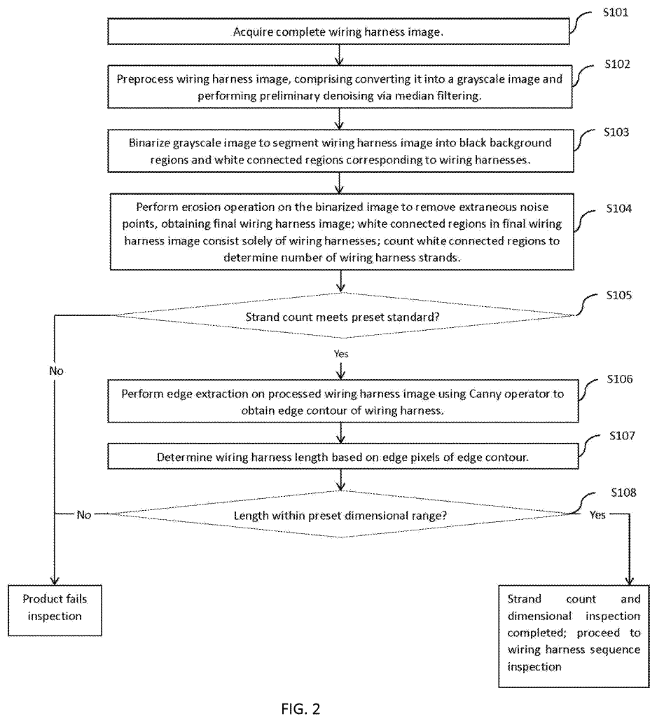

Referring to FIG. 2, a flowchart of a method for inspecting wire strand sequence and dimensions of an automotive wiring harness provided in Embodiment 2 of the present application is shown. As illustrated in FIG. 2, specific implementation steps of the above method comprise:

Step 101: Acquire a complete image of a wiring harness.

Step 102: Preprocess the wiring harness image, comprising converting the wiring harness image into a grayscale image and performing preliminary denoising via median filtering.

Specifically, the complete wiring harness image acquired by an industrial camera is an RGB color image, containing three color channels: red (R), green (G), and blue (B). In the embodiment of the present application, by converting the RGB image to the HSV color space and directly taking the Value V component as the grayscale image, the brightness information of the wiring harness image is retained while the color information of the wiring harness image is removed.

Furthermore, median filtering is performed on the grayscale image obtained above to remove noise from the image and smooth the image.

Step 103: Binarize the grayscale image to segment the wiring harness image into black background regions and white connected regions corresponding to wiring harnesses.

After converting the wiring harness image to the HSV color space, histograms of the image for the three components, Hue H, Saturation S, and Value V, are calculated respectively. The horizontal axis of a histogram represents the grayscale value of pixels, and the vertical axis represents the total number of pixels at that grayscale value.

Since the background region accounts for a large proportion and its pixel values are close, a “peak” with a large magnitude is formed in the low grayscale part of the histogram. The wiring harness region accounts for a relatively small proportion of the total image, forming a “peak” with a low magnitude in the higher grayscale region of the histogram. A “valley” is formed between the high “peak” and the low “peak”. The grayscale value corresponding to the lowest point of the “valley” is obtained. The average of the lowest values obtained from the histograms of the three components is taken as a threshold, as shown in Formula (1), where Tₕ, Tₛ, and Tᵥ are the grayscale values corresponding to the lowest points of the “valleys” in the histograms for the H, S, and V components, respectively.

$$f ( x ) = \{ \begin{matrix}0 , & x < \frac{1}{3} ( {T}_{h} + {T}_{s} + {T}_{v} ) \\ 255 , & x \geq \frac{1}{3} ( {T}_{h} + {T}_{s} + {T}_{v} )\end{matrix} \qquad ( 1 )$$

Binarization is performed on the wiring harness image according to the above threshold T. Pixel grayscale values greater than the threshold Tare set to 255, and pixel grayscale values less than the threshold T are set to 0, thereby segmenting the wiring harness image into black background regions and white connected regions corresponding to wiring harnesses.

Step 104: Perform an erosion operation on the binarized image to remove extraneous noise points, obtaining a final wiring harness image. The white connected regions in the final wiring harness image consist solely of wiring harnesses, which facilitates counting the number of white connected regions to determine the number of wiring harness strands.

Step 105: Determine whether the number of wiring harness strands conforms to a preset standard. If it conforms, proceed to Step 106. If it does not conform to the preset standard, the automotive wiring harness product is determined to be unqualified.

Step 106: Perform edge extraction on the processed wiring harness image using the Canny operator to obtain an edge contour of the wiring harness.

The embodiment of the present application extracts edge information of the wiring harness from the wiring harness image based on the Canny edge detection algorithm, and determines the edge contour of the wiring harness, providing a basis for further wiring harness structure analysis.

Specifically, the Canny edge detection algorithm comprises the following steps: The embodiment of the present application employs the Canny edge detection algorithm to extract edge information of the wiring harness from the wiring harness image, thereby determining its edge contour and laying the foundation for subsequent wiring harness structure analysis.

In practical applications, edge detection is susceptible to interference from image noise. Therefore, before performing edge detection, a Gaussian filter is first used to smooth the image, effectively reducing the impact of noise on the detection results. Subsequently, the gradient magnitude and direction for each pixel in the image are calculated using the Sobel operator. The gradient magnitude reflects the prominence of the edge, while the gradient direction indicates the orientation of the edge.

To further refine the edges, a non-maximum suppression operation is performed, retaining only the pixels with the maximum gradient magnitude while suppressing those that are not local maxima, thereby obtaining clearer and narrower edges. On this basis, the Canny edge detection algorithm also performs threshold detection and edge connection. Two thresholds are used, comprising a low threshold and a high threshold. Pixels with gradient magnitudes above the high threshold are considered strong edges, while pixels below the low threshold are suppressed. For pixels falling between the two thresholds, they are considered part of an edge only if they are connected to strong edge pixels. Finally, through edge tracking techniques, disconnected edges are connected to form complete contours, thereby achieving accurate extraction and depiction of the wiring harness edges.

Step 107: Determine the length of the wiring harness based on the edge pixels of the edge contour.

Specifically, H pixels are randomly selected on the edge contour of the wiring harness for a random Hough transform. By counting the peaks in the Hough space, the straight line with the most collinear points is found. The line with the most collinear points represents the entire wiring harness L, comprising a straight line portion I₁ and an arc portion I₂. It should be noted that the H is an adaptive threshold and needs to be adjusted according to the actual application scenario. When selecting the value, care should be taken to balance recognition accuracy and computation speed. If the value is too small, it may lead to significant recognition errors. If the value is too large, it may affect the computation speed.

The length of the straight line portion I₁ is calculated using the straight line equation y₁, i.e., the Euclidean distance between the two endpoints:

$${l}_{1} = \sqrt{{( {y}_{a} - {y}_{b} )}^{2} + {( {x}_{a} - {x}_{b} )}^{2}} \qquad ( 2 )$$

where A(xₐ,yₐ) and B(x_{b}, y_{b}) are the two endpoints of the straight line.

The length of the arc portion I₂ is calculated using the arc equation y₂:

$${l}_{2} = {\int }_{c}^{d} \sqrt{{[ {f}^{′} ( x ) ]}^{2} + 1} d x \qquad ( 3 )$$

where c and d are the abscissas of the two endpoints of the arc.

The sum of the lengths of the straight line portion I₁ and the arc portion I₂ is taken as the length of the wiring harness in the image, whereby the actual length of the wiring harness can be determined based on a preset scale factor.

Step 108: Determine whether the wiring harness length conforms to a preset dimensional range. If yes, the product is determined to be qualified, and the wiring harness sequence inspection is continued. If the calculated wiring harness length is not within the above preset dimensional range, the product is determined to be unqualified.

Specifically, since the Hough transform can only recognize curves that can be expressed by formulas, and the bent part of an actual wiring harness is not a standard arc and cannot be represented by a curve formula, an error exists between the measured value and the actual value. Before actual production, it is necessary to first measure n groups of different sample wiring harnesses, and calculate the error uᵢ=Aᵢ−Mᵢ between the actual value Aᵢ and the measured value Mᵢ for each group of sample wiring harnesses, as well as the average error

$${u}_{0} = \frac{1}{n} {\sum }_{i = 1}^{n} {u}_{i} .$$

The error threshold ε₀ is calculated as:

$${ε}_{0} = \frac{1}{n} {\sum }_{i = 1}^{n} {( {u}_{i} - {u}_{0} )}^{2} \qquad ( 4 )$$

Then, the same sample wiring harness is measured m times to obtain several measured values

$${M}_{i}^{′}$$

for the same wiring harness. The systematic error ε₁ of the computer based on the measured values is calculated as:

$${ε}_{1} = \frac{1}{m} {\sum }_{i = 1}^{m} {( {M}_{i}^{′} - {M}_{0}^{′} )}^{2} \qquad ( 5 )$$

After calculating the actual length of the wiring harness through the based on the image-to-actual scale factor, if the difference between the wiring harness length and a preset template value is within the threshold range (ε₀+ε₁), it is determined that the wiring harness length of the wiring harness conforms to the preset dimensional range, and the wiring harness dimension is deemed qualified.

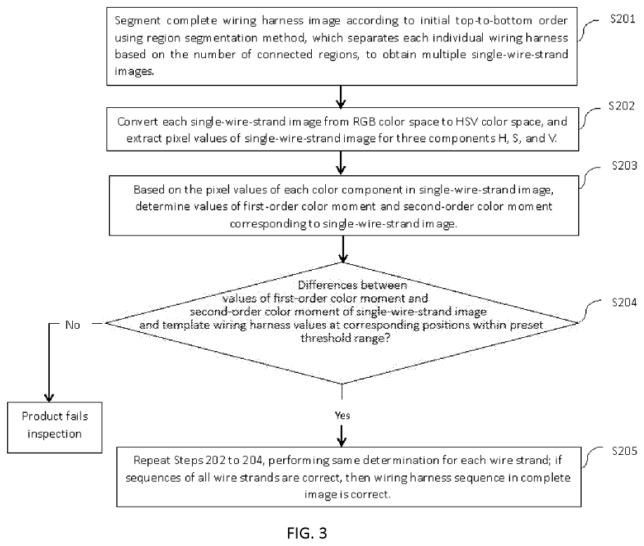

Referring to FIG. 3, a flowchart of a method for inspecting a wiring harness sequence of an automotive wiring harness provided in an embodiment of the present application is shown. As illustrated in FIG. 3, specific implementation steps of the above method comprise:

Step 201: Segment a complete wiring harness image according to an initial top-to-bottom order using a region segmentation method, which separates each individual wiring harness based on the number of connected regions, to obtain multiple single-wire-strand images.

Step 202: Convert each single-wire-strand image from the RGB color space to the HSV color space, and extract pixel values of the single-wire-strand image for the three components H, S, and V.

Step 203: Based on the pixel values of each color component in the single-wire-strand image, determine values of a first-order color moment and a second-order color moment corresponding to the single-wire-strand image, for characterizing color features and distribution characteristics of the single-wire-strand image.

Specifically, the value of the first-order color moment corresponding to the single-wire-strand image is calculated using Formula (6), expressed as:

$${e}_{i} = \frac{1}{N} {\sum }_{j = 1}^{N} {P}_{i , j} \qquad ( 6 )$$

where N represents the total number of pixels in the single-wire-strand image, P_{i,j} represents the j-th pixel value of the i-th color component, and eᵢ represents the mean of all pixels of the i-th color component, i.e., the value of the first-order color moment.

The value of the second-order color moment corresponding to the single-wire-strand image is calculated using Formula (7), expressed as:

$${S}_{i} = {[ \frac{1}{N} {\sum }_{j = 1}^{N} {( {P}_{i , j} - {e}_{i} )}^{2} ]}^{\frac{1}{2}} \qquad ( 7 )$$

where Sᵢ represents the variance of all pixels of the i-th color component, i.e., the second-order color moment.

Step 204: Calculate differences between the values of the first-order color moment and the second-order color moment corresponding to the single-wire-strand image and template wiring harness values at corresponding positions, and determine whether the above differences are within a preset threshold range. If they are, it indicates that the sequence of the single wire strand is correct.

Step 205: Repeat Steps 202 to 204, performing the same determination for each wire strand. If the sequences of all wire strands are correct, then the wiring harness sequence in this complete image is correct.

Wiring harnesses that have been verified, comprising those with correct strand count and correct sequence, are precisely matched with preset wiring harness dimensional standards. Subsequently, the system will display detailed information for each wiring harness that meets the standards, comprising its unique color and precise dimensions. This process not only ensures the accuracy and consistency of the wiring harness but also provides strong support for quality control and production monitoring through visualization, thereby significantly enhancing the automation and intelligence level in the wiring harness manufacturing process and ensuring the quality and reliability of the final product.

After completing the wiring harness dimension and sequence inspection, the wiring harness crimping defect inspection stage begins. The purpose of this stage is to ensure that no defects occurred during the crimping process of the wiring harness, such as insecure crimping, crimping damage, and other issues. Below, the vision-based recognition method for inspecting wiring harness crimping defects provided by the present application is described in detail with reference to specific embodiments.

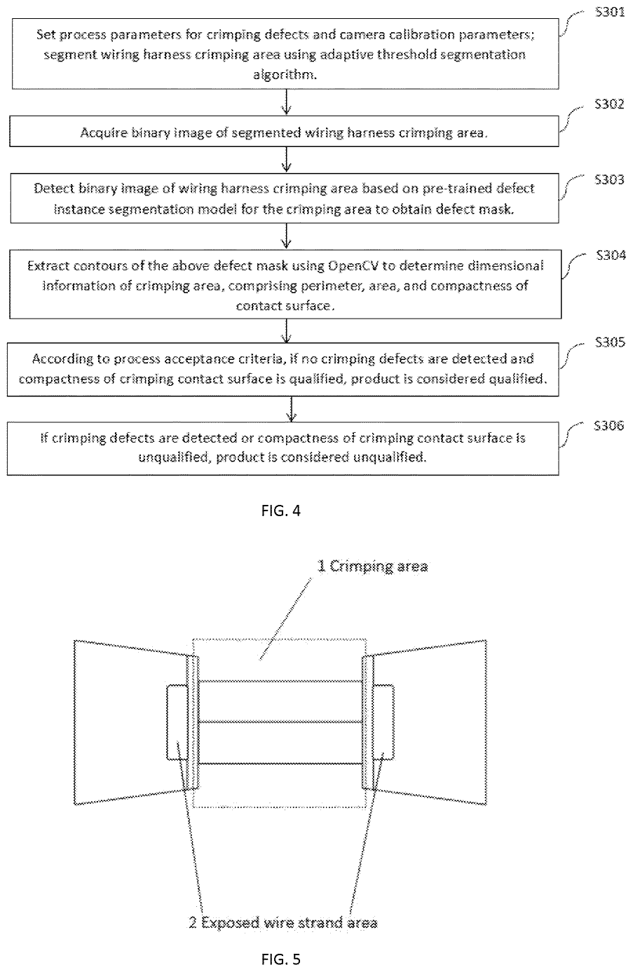

Referring to FIG. 4, a flowchart of a method for inspecting wiring harness crimping defects provided in Embodiment 2 of the present application is shown. As illustrated in FIG. 4, specific implementation steps of the above method comprise:

Step 301: Set process parameters for crimping defects and camera calibration parameters, and segment a wiring harness crimping area using an adaptive threshold segmentation algorithm.

Before performing wiring harness crimping defect inspection, appropriate process parameters and camera calibration parameters need to be set. Process parameters comprise crimping height, width, crimping speed, crimping force, and the pressure, temperature, time required during the crimping process, which need to be determined based on the material characteristics of the wiring harness and crimping requirements. Camera calibration parameters relate to the internal parameters and external parameters of the camera. Internal parameters comprise, for example, focal length, pixel size, etc. External parameters comprise, for example, the distance and angle between the camera and the object being photographed. These parameters are accurately calibrated to ensure the accuracy of subsequent image processing.

After completing the parameter settings, an adaptive threshold segmentation algorithm is used to segment the crimping area. Adaptive threshold segmentation can dynamically adjust the threshold based on the local characteristics of the image, thereby achieving image segmentation and separating the crimping area from the background. Referring to FIG. 5, a schematic diagram of a wiring harness crimping area provided in Embodiment 2 of the present application is shown.

Step 302: Acquire a binary image of the segmented wiring harness crimping area.

In one achievable manner, a 3×3 neighborhood window is defined centered on a current pixel, comprising the center pixel and its 8 adjacent surrounding pixels. The mean of the grayscale values of all pixels within the above 3×3 neighborhood window is calculated. The above mean is taken as the threshold T(x, y) for the current pixel, as shown in Formula (8).

$$T ( x , y ) = {\sum }_{( i . j ) ∋ W} I ( i , j ) - C \qquad ( 8 )$$

where T(x, y) represents the threshold for the current pixel, W represents the neighborhood window centered on the current pixel, I(i, j) represents the grayscale value of the pixel within the window, and C is a constant used to adjust the sensitivity of segmentation.

Furthermore, the grayscale value of the current pixel is compared with the calculated threshold T(x, y). If the grayscale value of the current pixel is greater than the threshold (i.e., I(x, y)>T(x, y)), the pixel is set to white. Otherwise, it is set to black.

The above steps are repeated to process each pixel in the image of the wiring harness crimping area, ultimately generating a binary image of the wiring harness crimping area. In the binary image, white areas represent the wiring harness crimping area, while black areas represent the background or other non-crimping parts. Through this method, the wiring harness crimping area can be effectively extracted from the original image, providing clear image data for subsequent defect detection and analysis. The adaptive threshold segmentation algorithm can dynamically adjust the threshold based on the local characteristics of the image, thereby better adapting to changes in different lighting conditions and image content, improving the accuracy and robustness of segmentation.

Step 303: Detect the binary image of the wiring harness crimping area based on a pre-trained defect instance segmentation model for the crimping area to obtain a defect mask.

In the embodiment of the present application, multiple images containing various types of crimping defects are pre-acquired, comprising images of crack defects, crimping shape abnormality defects, crimping surface oxidation defects, and wire strand exposure defects in the crimping area. All images are annotated using Labelme software.

A crimping area defect dataset is constructed based on the above images. A YOLACT instance segmentation model is configured, with ResNet50 as the backbone network, and the number of masks is set to 32. Defect categories for detection are defined, comprising crack, abnormal crimping shape, crimping surface oxidation, and wire strand exposure in the crimping area.

The above crimping area defect dataset is input into the configured YOLACT instance segmentation model, and feature information is extracted through the backbone network, expressed as:

$$F ∈ {R}^{C \times H \times W} \qquad ( 9 )$$

where F represents the feature map dimension, C represents the number of feature channels, H represents the height of the feature map, and W represents the width of the feature map.

Furthermore, dimensionality reduction is performed on the feature map dimension F. A 1×1 convolution kernel is used to reduce the number of feature channels C of the feature map dimension F to 32, which serves as the number of shared mask prototypes. The shared mask dimension P is calculated using Formula (10), expressed as:

$$P ∈ {R}^{M \times H \times W} \qquad ( 10 )$$

The original prediction values Cᵢ of the YOLACT instance segmentation model are normalized through an activation function to obtain mask weight coefficients cᵢₘ. The mask weight coefficients are a set of scalar values representing the contribution of a shared mask prototype to a specific target instance, as shown in Formulas (11) and (12), expressed as:

$${C}_{i} = \{ {C}_{i 1} , {C}_{i 2} , … , {C}_{iM} \} \qquad ( 11 )$$

$${c}_{i m} = sigmoid ( {C}_{i} ) \qquad ( 12 )$$

A linear combination of the shared masks is performed using the above coefficients to generate a final instance mask Mᵢ(x, y), as shown in Formula (13), i.e., obtaining a trained defect instance segmentation model for the crimping area, expressed as:

$${\hat{M}}_{i} ( x , y ) = {\sum }_{m = 1}^{M} {C}_{im} \times {P}_{m} ( x , y ) \qquad ( 13 )$$

where M represents the number of shared masks, \hat{M}ᵢ(x, y) represents the final mask for the i-th instance, Pₘ(x, y) represents the m-th shared mask prototype, and Cᵢₘ represents the m-th weight for instance i.

Finally, a binary cross-entropy loss function is used to optimize the network, as shown in Formula (14), improving the quality of the generated masks, making them more accurately represent the shape and position of objects, enhancing the accuracy of target detection, and strengthening the ability to distinguish between different types of targets comprising cracks, abnormal crimping shapes, crimping surface oxidation, and wire strand exposure in the crimping area.

$${L}_{m a s k} = - \frac{1}{N} {\sum }_{i = 1}^{N} {\sum }_{( x , y )} [ {M}_{i} ( x , y ) log ( {\hat{M}}_{i} ( x , y ) ) + ( 1 - {M}_{i} ( x , y ) log ( 1 - {\hat{M}}_{i} ( x , y ) ) ) ] \qquad ( 14 )$$

where Mᵢ(x, y) is the ground truth mask annotated by Labelme software, and \hat{M}ᵢ(x, y) is the predicted mask.

The binary image of the wiring harness crimping area is detected using the above optimized defect instance segmentation model forthe crimping area to obtain a defect mask, used to mark areas where defects exist in the wiring harness crimping area. Based on the above defect mask, the defect type corresponding to the area where defects exist in the wiring harness crimping area is determined, comprising crack, abnormal crimping shape, crimping surface oxidation, wire strand exposure in the crimping area, etc. In the embodiment of the present application, the above recognition results are uploaded to an industrial computer, thereby achieving automated quality monitoring and defect management. This not only improves detection efficiency and accuracy but also provides important data support for subsequent production process optimization and quality control, further enhancing the intelligence level and responsiveness of the production line.

Step 304: Extract contours of the above defect mask using OpenCV to determine dimensional information of the crimping area.

Specifically, the dimensional information of the crimping area comprises the perimeter, area, and compactness of the contact surface. See below for specific calculation methods.

In the embodiment of the present application, contour information is extracted from the mask image of the wiring harness crimping area based on OpenCV. A contour is a set of wiring harness edges in the image, which can be represented as a series of points defining the boundary of the crimping area. Let the point set of the image contour of the crimping area be contour, expressed as:

$$contour = \{ ( {x}_{1} , {y}_{1} ) , ( {x}_{2} , {y}_{2} ) , … , ( {x}_{n} , {y}_{n} ) \} \qquad ( 15 )$$

Based on the above contour, the distance di between adjacent points is calculated, expressed as:

$${d}_{i} = \sqrt{{( {x}_{i + 1} - {x}_{i} )}^{2} + {( {y}_{i + 1} - {y}_{i} )}^{2}} , i = 1 , 2 , … , n ; ( 16 ) \qquad ( 16 )$$

where (xᵢ, yᵢ) are the coordinates of the i-th point on the contour, n is the total number of contour points, xₙ₊₁=x₁,yₙ₊₁=y₁.

Based on the above distances between adjacent points, the contour perimeter D is determined, expressed as:

$$D = {\sum }_{i = 1}^{n} {d}_{i} \qquad ( 17 )$$

The area extraction method is as follows:

Based on the calculation formula for the area of a polygon, the area A of the contact surface in the crimping area is determined, expressed as:

$$A = \frac{1}{2} \vert {\sum }_{i = 1}^{n} ( {x}_{i} {y}_{i + 1} - {x}_{i + 1} {y}_{i} ) \vert \qquad ( 18 )$$

where (xᵢ, yᵢ) are the coordinates of the i-th point on the contour, n is the total number of contour points, xₙ₊₁=x₁, yₙ₊₁=y₁.

The compactness of the contact surface in the crimping area is determined using the perimeter and area calculated above, expressed as:

$$Compactness = \frac{{D}^{2}}{4 π \times A} \qquad ( 19 )$$

Through the calculated perimeter, area, and compactness, the quality of the crimping area can be evaluated. For example, compactness can serve as a criterion for the acceptability of the crimping contact area. The greater the compactness of the contact surface, the more irregular the shape of the contact surface.

The present embodiment obtains key dimensional information of the crimping area from the image through contour extraction and geometric calculation, and uses the information to evaluate crimping quality, automatically detecting and analyzing the wiring harness crimping area, thereby improving production efficiency and product quality.

Step 305: Referring to process acceptance criteria, if no crimping defects are detected and the compactness of the crimping contact surface is qualified, the product is determined to be qualified.

Step 306: If a crimping defect is detected or the compactness of the crimping contact surface is unqualified, the product is determined to be unqualified.

In practical application scenarios, the automated wiring harness crimping inspection system outputs the above visual inspection results in real time to the display and control module. If the inspection results indicate that the wiring harness crimping quality meets the preset process standards, the display will show information indicating “Conforms to process standards, crimping qualified”. At the same time, this result will be automatically recorded and stored in the system database for subsequent quality tracking and analysis. Such an immediate feedback mechanism not only improves production efficiency but also ensures consistency in product quality.

Conversely, if the inspection results show that the wiring harness crimping has defects, such as cracks, abnormal crimping shapes, crimping surface oxidation, or wire strand exposure in the crimping area, the display will clearly indicate “Crimping defect present, crimping unqualified” and list the specific defect types in detail. The information is also stored in the system database, providing key data for the quality control team so they can promptly take corrective actions, optimize production processes, and reduce the generation of unqualified products.

### Embodiment 3

The present Embodiment 3 provides a comprehensive description of all technical solutions provided in the foregoing Embodiment 2, and describes in detail, with reference to specific embodiments, a method for inspecting wire strand sequence and dimensions as well as crimping defects of an automotive wiring harness based on a wiring harness image.

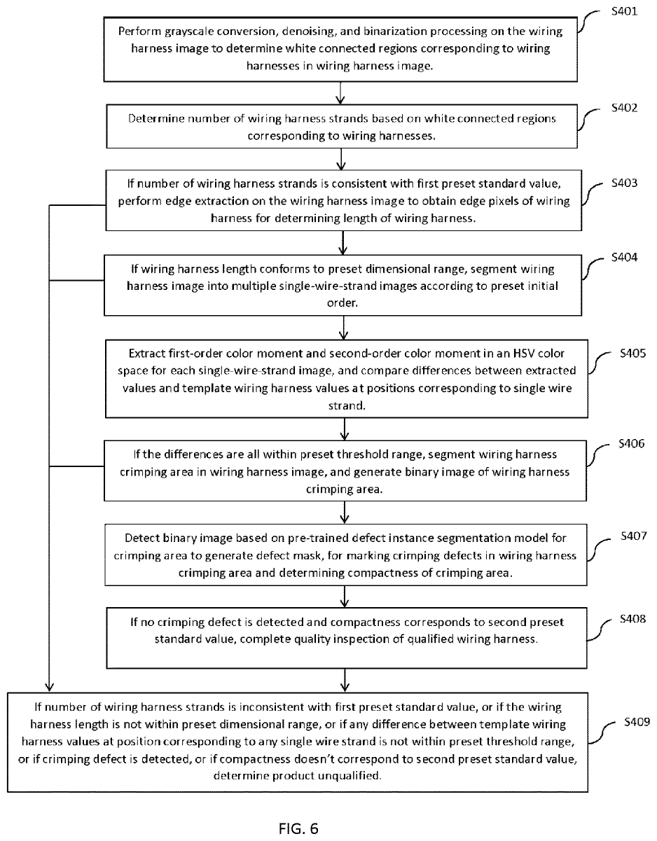

Referring to FIG. 6, a flowchart of a method for inspecting crimping quality of an automotive wiring harness provided in Embodiment 3 of the present application is shown. As illustrated in FIG. 6, specific implementation steps of the above method comprise:

Step 401: Perform grayscale conversion, denoising, and binarization processing on the wiring harness image to determine white connected regions corresponding to wiring harnesses in the wiring harness image.

Step 402: Determine the number of wiring harness strands based on the white connected regions corresponding to wiring harnesses.

Step 403: If the number of wiring harness strands is consistent with a first preset standard value, perform edge extraction on the wiring harness image to obtain edge pixels of the wiring harness, so as to determine a length of the wiring harness.

Step 404: If the wiring harness length conforms to a preset dimensional range, segment the wiring harness image into a plurality of single-wire-strand images according to a preset initial order.

Step 405: Extract a first-order color moment and a second-order color moment in an HSV color space for each single-wire-strand image, and compare differences between the extracted values and template wiring harness values at positions corresponding to the single wire strand.

Step 406: If the differences are all within a preset threshold range, segment a wiring harness crimping area in the wiring harness image, and generate a binary image of the wiring harness crimping area.

Step 407: Detect the binary image based on a pre-trained defect instance segmentation model for a crimping area to generate a defect mask, for marking crimping defects in the wiring harness crimping area and determining a compactness of the crimping area, wherein the compactness is determined by a perimeter and an area of a contact surface of the crimping area.

Step 408: If no crimping defect is detected and the compactness is consistent with a second preset standard value, complete quality inspection of a qualified wiring harness.

Step 409: If the number of wiring harness strands is inconsistent with the first preset standard value, or if the wiring harness length is not within the preset dimensional range, or if any difference between template wiring harness values at a position corresponding to any single wire strand is not within the preset threshold range, or if a crimping defect is detected, or if the compactness is inconsistent with the second preset standard value, determine that the product is unqualified.

It should be noted that specific implementation methods for each step in the embodiment of the present application refer to the foregoing Embodiment 2, and will not be repeated in this Embodiment 3.

Compared with the prior art, the technical solution provided by the embodiment of the present application has the following beneficial effects:

The present application achieves efficient and accurate inspection of wiring harness quality through a combination of image processing and deep learning. First, by performing preprocessing operations such as denoising, grayscale conversion, binarization, and edge extraction on the wiring harness image, image noise can be effectively removed, and connected regions and edge features of the wiring harness can be clearly identified, providing an accurate basis for subsequent counting of wiring harness strands and length measurement. Second, feature extraction is performed using first-order and second-order color moments in the HSV color space, and the extracted features are compared with template wiring harness values, enabling rapid determination of whether the color characteristics of the wiring harness meet standards, thereby improving detection sensitivity and accuracy. Furthermore, the wiring harness crimping area is detected based on a pre-trained defect instance segmentation model for a crimping area, enabling accurate identification of crimping defects and generation of a defect mask, while further verifying crimping quality by calculating the compactness of the contact surface. The overall solution not only achieves comprehensive inspection of wiring harness quality, but also greatly improves inspection efficiency, reduces errors and labor intensity of manual inspection, and has high practicality and reliability. It can be effectively applied to quality control processes in wiring harness production, ensuring high quality and consistency of wiring harness products.

Although embodiments of the present application have been shown and described, it will be understood by those of ordinary skill in the art that various changes, modifications, substitutions, and alterations can be made to these embodiments without departing from the principles and spirit of the present application. The scope of the present application is defined by the appended claims and their equivalents.

1. A visual inspection method for crimping quality of automotive wiring harnesses, sequentially performing wire strand sequence inspection, dimension inspection, and crimping defect inspection on a wiring harness based on an image thereof, the method comprising:
processing an image of the wiring harness through grayscale conversion, denoising, and binarization to identify white connected regions corresponding to wiring harnesses within the harness image;
determining the number of wire strands based on the white connected regions corresponding to wiring harnesses;
in response to the number of wire strands matching a first preset standard value, performing edge extraction on the harness image to obtain edge pixels of the wire strands and determining a length of the wiring harness based on the edge pixels;
in response to the length conforming to a preset dimensional range, segmenting the harness image into a plurality of single-wire-strand images according to a preset initial sequence;
extracting first-order and second-order color moments for each single-wire-strand image in an HSV color space, and comparing differences between the extracted color moments and template values for corresponding positions of single wire strands;
in response to all the differences being within a preset threshold range, cropping a wiring harness crimping area from the harness image and generating a binary image of the wiring harness crimping area;
processing the binary image using a pre-trained defect instance segmentation model for crimping areas to generate a defect mask, wherein the defect mask marks crimping defects within the wiring harness crimping area and is used to determine a compactness of the crimping area based on a perimeter and an area of a contact surface thereof, and
in response to processing no crimping defect and the compactness matching a second preset standard value, completing quality inspection for a qualified wiring harness;
wherein the pre-trained defect instance segmentation model for crimping areas is a YOLACT instance segmentation model, using ResNet50 as a backbone network;
wherein training the defect instance segmentation model for crimping areas comprises:
acquiring a plurality of images containing various types of crimping defects to construct a crimping area defect dataset, wherein the types of crimping defects comprise crack defects, abnormal crimping shape defects, crimping surface oxidation defects, and wire strand exposure defects in crimping areas:
inputting the crimping area defect dataset into a configured YOLACT instance segmentation model, and extracting feature information through the backbone network, the feature information being expressed as:
$$F ∈ {R}^{C \times H \times W} \qquad ( 9 )$$
where F represents the feature map dimension, C represents the number of feature channels, H represents a height of the feature map, and W represents a width of the feature map;
performing dimensionality reduction on the feature tensor F, using a 1×1 convolution kernel to reduce the number of feature channels C in the feature tensor F to 32 to serve as the number of shared mask prototypes;
determining a shared mask dimension P, expressed as:
$$P ∈ {R}^{M \times H \times W} \qquad ( 10 )$$
performing normalization on an original prediction value Ci of the YOLACT instance segmentation model through an activation function to obtain mask weight coefficients cᵢₘ, wherein the mask weight coefficients characterize a contribution degree of shared mask prototypes to a specific target instance, expressed as:
$${C}_{i} = \{ {C}_{i 1} , {C}_{i 2} , … , {C}_{i M} \} \qquad ( 11 )$$
$${c}_{i m} = sigmoid ( {C}_{i} )$$
performing a linear combination on the shared masks to generate a final instance mask \hat{M}ᵢ(x, y), thereby obtaining the trained defect instance segmentation model for crimping areas, expressed as:
$${\hat{M}}_{i} ( x , y ) = {\sum }_{m = 1}^{M} {C}_{i m} \times {P}_{m} ( x , y ) \qquad ( 13 )$$
where M represents the number of shared masks, \hat{M}ᵢ(x, y) represents a final mask for an i-th instance, Pₘ(x, y) represents an m-th shared mask prototype, and Cᵢₘ represents an m-th weight for the instance i; and
optimizing the network using a binary cross-entropy loss function to enhance an ability of the defect instance segmentation model for crimping areas to distinguish between different types of crimping defects, the loss function being expressed as:
$${L}_{m a s k} = - \frac{1}{N} {\sum }_{i = 1}^{N} {\sum }_{( x , y )} [ {M}_{i} ( x , y ) log ( {\hat{M}}_{i} ( x , y ) ) + ( 1 - {M}_{i} ( x , y ) log ( 1 - {\hat{M}}_{i} ( x , y ) ) ) ] \qquad ( 14 )$$
where Mᵢ (x, y) represents a ground truth mask annotated using Labelme software, and \hat{M}ᵢ (x, y) represents a predicted mask.

2. The visual inspection method for crimping quality of automotive wiring harnesses according to claim 1, wherein processing the harness image through grayscale conversion, denoising, and binarization comprises:
converting the harness image to the HSV color space and using a Value (V) component thereof as a grayscale image;
performing median filtering on the grayscale image to remove noise and smooth the harness image; and
performing binarization on the denoised grayscale image to segment the harness image into a black background region and the white connected regions corresponding to wiring harnesses.

3. The visual inspection method for crimping quality of automotive wiring harnesses according to claim 1, wherein determining the number of wire strands based on the white connected regions corresponding to wiring harnesses:
performing an erosion operation on the binarized image to remove extraneous noise points, thereby obtaining a final wiring harness image; wherein the white connected regions corresponding to wiring harnesses in the final wiring harness image consist solely of the wire strands and are used to determine the number of wire strands.

4. The visual inspection method for crimping quality of automotive wiring harnesses according to claim 1, wherein performing edge extraction on the harness image to obtain edge pixels of the wire strands, and determining a length of the wiring harness comprises:
extracting edge information of the wire strands from the harness image based on a Canny edge detection algorithm to determine an edge contour;
randomly selecting N pixel points on the edge contour to perform a Randomized Hough Transform;
identifying a line with a maximum number of collinear points by analyzing peaks in a Hough space as an entire harness line L, the harness line L comprising a straight-line segment I₁, and a curved segment I₂;
calculating a length of the straight-line segment I₁, wherein the length is a Euclidean distance between two endpoints of the straight-line segment I₁ and is calculated using a linear equation yᵢ thereof:
$${l}_{1} = \sqrt{{( {y}_{a} - {y}_{b} )}^{2} + {( {x}_{a} - {x}_{b} )}^{2}} \qquad ( 2 )$$
where A(xₐ, yₐ),B(x_{b}, y_{b}) are the two endpoints of the straight-line segment;
calculating a length of the curved segment I₂, wherein the length is calculated using a curve equation y₂ thereof:
$${l}_{2} = {\int }_{c}^{d} \sqrt{{[ {f}^{′} ( x ) ]}^{2} + 1} dx \qquad ( 3 )$$
where c and d are horizontal coordinates of the two endpoints of the curved segment;
using a sum of the length of the straight-line segment I₁ and the length of the curved segment I₂ as the length of the wiring harness in the harness image; and
determining an actual length of the wiring harness based on a length of the wiring harness in the harness image and a preset scaling factor.

5. The visual inspection method for crimping quality of automotive wiring harnesses according to claim 4, wherein determining the preset dimensional range comprises:
selecting n different sets of sample harnesses, and for each set i, calculating an error uᵢ=Aᵢ−Mᵢ between an actual value Aᵢ and a measured value Mᵢ; calculating an average error
$${u}_{0} = \frac{1}{n} {\sum }_{i = 1}^{n} {u}_{i} ;$$
calculating an error threshold ε₀, expressed as:
$${ε}_{0} = \frac{1}{n} {\sum }_{i = 1}^{n} {( {u}_{i} - {u}_{0} )}^{2}$$
measuring a same sample harness m times to obtain a plurality of measured values M′ᵢ for that same sample harness, and determining a systematic error ε₁, expressed as:
$${ε}_{1} = \frac{1}{m} {\sum }_{i = 1}^{m} {( {M}_{i}^{′} - {M}_{0}^{′} )}^{2}$$
where determining the preset dimensional range based on the error threshold ε₀, the systematic error ε₁, and a preset template value; wherein the length of the wiring harness is determined to conform to the preset dimensional range if a difference between the length of the wiring harness and the preset template value is within a threshold range of (ε₀+ε₁).

6. The visual inspection method for crimping quality of automotive wiring harnesses according to claim 1, wherein extracting the first-order and second-order color moments for each single-wire-strand image in the HSV color space comprises:
extracting pixel values of the single-wire-strand image on the H, S, and V color components;
determining the first-order color moment and the second-order color moment corresponding to the single-wire-strand image based on the pixel values; wherein the first-order color moment is expressed as:
$${e}_{i} = \frac{1}{N} {\sum }_{j = 1}^{N} {P}_{i , j} \qquad ( 6 )$$
where N represents a total number of pixels in the single-wire-strand image, P_{i,j} represents a j-th pixel value of an i-th color component, and eᵢ represents a mean value of all pixels for the i-th color component, which is a value of the first-order color moment;
wherein the second-order color moment is expressed as:
$${S}_{i} = {[ \frac{1}{N} {\sum }_{j = 1}^{N} {( {P}_{i , j} - {e}_{i} )}^{2} ]}^{\frac{1}{2}} \qquad ( 7 )$$
where Sᵢ represents a variance of all pixels for the i-th color component, which is the second-order color moment.

7. The visual inspection method for crimping quality of automotive wiring harnesses according to claim 1, wherein cropping the wiring harness crimping area from the harness image and generating the binary image of the wiring harness crimping area comprises:
cropping the wiring harness crimping area from the harness image based on an adaptive threshold segmentation algorithm;
for each pixel in an image of the cropped wiring harness crimping area, with the pixel as a center, defining a 3×3 neighborhood window that consists of the center pixel and eight adjacent pixels surrounding the center pixel;
calculating a mean of grayscale values of all pixels within the 3×3 neighborhood window;
using the mean as a threshold T(x,y) for the current pixel, expressed as:
$$T ( x , y ) = {\sum }_{( i . j ) ∋ W} I ( i , j ) - C \qquad ( 8 )$$
where T(x,y) represents the threshold for the current pixel, W represents the neighborhood window centered on the current pixel, I(i, j) represents the grayscale value of a pixel within the neighborhood window, and C represents a constant for adjusting segmentation sensitivity;
comparing the grayscale value of the current pixel with the calculated threshold T(x, y); setting the current pixel to white if the grayscale value of the current pixel is greater than T(x, y); setting the current pixel to black if the grayscale value of the current pixel is less than or equal to T(x, y);
repeating the foregoing steps for each pixel in the image of the wiring harness crimping area to generate the binary image of the wiring harness crimping area; wherein a white region in the binary image represents the wiring harness crimping area of the wiring harness, and a black region represents a background or other non-crimping areas.

8. (canceled)

9. The visual inspection method for crimping quality of automotive wiring harnesses according to claim 1, wherein marking crimping defects within the wiring harness crimping area and determining a compactness of the wiring harness crimping area based on the defect mask comprises:
performing contour extraction on the defect mask using OpenCV to obtain a point set of an image contour of the crimping area, expressed as:
$$contour = \{ ( {x}_{1} , {y}_{1} ) , ( {x}_{2} , {y}_{2} ) , … , ( {x}_{n} , {y}_{n} ) \} \qquad ( 15 )$$
calculating a distance di between adjacent points based on the contour, expressed as:
$${d}_{i} = \sqrt{{( {x}_{i + 1} - {x}_{i} )}^{2} + {( {y}_{i + 1} - {y}_{i} )}^{2}} , i = 1 , 2 , … , n ; \qquad ( 16 )$$
where (xᵢyᵢ) represents coordinates of an i-th point on the contour, n represents a total number of contour points, and xₙ₊₁=x₁,yₙ₊₁=y₁;
determining a contour perimeter D based on the distances between adjacent points, expressed as:
$$D = {\sum }_{i = 1}^{n} {d}_{i} \qquad ( 17 )$$
determining an area A of the contact surface of the crimping area based on a polygon area calculation formula, expressed as:
$$A = \frac{1}{2} \vert {\sum }_{i = 1}^{n} ( {x}_{i} {y}_{i + 1} - {x}_{i + 1} {y}_{i} ) \vert \qquad ( 18 )$$
where (xᵢ,yᵢ) represents coordinates of an i-th point on the contour, n represents a total number of contour points, and xₙ₊₁=x₁,yₙ₊₁=y₁;
and determining a compactness of the contact surface of the crimping area based on the perimeter D and the area A, expressed as:
$$Compactness = \frac{{D}^{2}}{4 π \times A} . \qquad ( 19 )$$
